(19) United States
(12) Patent Application Publication
(10) Pub. No.: US 2016/0012078 A1
(43) Pub. Date: Jan. 14, 2016

(54) INTELLIGENT MEDIA MANAGEMENT SYSTEM

(71) Applicant: Phetch LLC, Memphis, TN (US)

(72) Inventors: Ephraim Gabriel Kutner, Lawrence, NY (US); Rena Rachel Kutner, Lawrence, NY (US); Aaron David Kutner, Lawrence, NY (US); Gershon Yarmush, Oceanside, NY (US); Andrew Michael Moeck, Huntington Beach, CA (US); James Sinclair, Los Angeles, CA (US)

(21) Appl. No.: 14/799,473

(22) Filed: Jul. 14, 2015

Related U.S. Application Data
(60) Provisional application No. 62/024,346, filed on Jul. 14, 2014.

(51) Int. Cl. G06F 17/30

(52) U.S. Cl. CPC G06F 17/30265; G06F 17/30528; G06F 17/30554; G06F 17/30507; G06F 17/30864

(57) ABSTRACT

An intelligent media management system can facilitate more organized storage of media, including photos and video. The system can be a platform that sorts media into micro groups based on sets of comparable photos, where the groups can be defined by event, sequence, people, actions, context, or other criteria. The system can include back-end technology created for the intelligent recalling of specific images (algorithms and intelligent processing) and a front-end application that delivers this data to the consumer user (e.g., an application or app). The front-end application can include a search engine that enables the user to search the micro-groups to find relevant photos and video more quickly than is possible with currently-available camera applications.

### INCORPORATION BY REFERENCE TO ANY PRIORITY APPLICATIONS

Any and all applications, if any, for which a foreign or domestic priority claim is identified in the Application Data Sheet of the present application are hereby incorporated by reference under 37 CFR 1.57.

### BACKGROUND

Consumers use camera applications daily to take pictures and video on mobile devices such as cell phones, smartphones, tablets, and the like. Many consumers now use their mobile devices exclusively in place of digital cameras for capturing both still images and video. Some consumers take hundreds or even thousands of pictures and videos a year.

### SUMMARY

In certain embodiments, a media management method includes, under control of a user device comprising a hardware processor, accessing initial metadata associated with content obtained by a camera, using the initial metadata to obtain enhanced metadata, associating the enhanced metadata with the content in computer storage of the user device, subsequently receiving a user request to search media items, the user request comprising one or more keywords, and in response to receiving the user request, searching the enhanced metadata with the one or more keywords to identify one or more of the media items associated with the enhanced metadata, and outputting the one or more media items for presentation to the user.

In certain embodiments, the method of the preceding paragraph can be implemented together with any subcombination of the following features: wherein said using the initial metadata to obtain enhanced metadata includes requesting the enhanced metadata from a remote server; wherein the initial metadata includes one or more of the following: a date associated with the one or more media items, a time associated with the one or more media items, and a location associated with the one or more media items; wherein the location includes a latitude value and a longitude value;

wherein the enhanced metadata includes a location represented other than by latitude and longitude, which is received in response to sending the latitude value and the longitude value to a remote server; wherein said using includes using the initial metadata to access the enhanced metadata from a calendar application used by the user device; further including presenting the enhanced metadata to the user for review and optional revision; further including using the enhanced metadata to obtain second enhanced metadata; wherein the enhanced metadata comprises a location and the second enhanced metadata includes an event that occurred at the location; and wherein said searching further includes searching the initial metadata.

In various embodiments, a media management system includes a user device including a hardware processor programmed with executable instructions stored in a memory. The executable instructions can access initial metadata associated with content obtained by a camera, use the initial metadata to obtain enhanced metadata, associate the enhanced metadata with the content in computer storage of the user device, subsequently receive a user request to search media items, the user request including one or more keywords, and in response to receipt of the user request, search the enhanced metadata with the one or more keywords to identify one or more of the media items associated with the enhanced metadata, and output the one or more media items for presentation to the user.

In certain embodiments, the system of the preceding paragraph can be implemented together with any subcombination of the following features: wherein the initial metadata includes a tag created by vocal recognition software; wherein the instructions further comprise functionality to organize the media items into folders; wherein the instructions further comprise functionality to share one of the folders with a remote user; and wherein the instructions further comprise functionality to order printing of one or more of the media items.

Further, in some embodiments, non-transitory physical computer storage includes instructions stored thereon that, when executed by one or more processors, causes the one or more processors to implement media management operations. The operations can include identifying metadata associated with media items, the media items generated by a camera of a user device, associating the metadata with the media items in computer storage of the user device, subsequently receiving a user request to conduct a search on the user device to find one or more of the media items generated by the camera of the user device, the user request including one or more keywords, and in response to receiving the user request, searching the metadata with the one or more keywords to identify one or more of the media items associated with the metadata, and outputting the one or more media items corresponding to the one or more keywords for presentation to the user.

In certain embodiments, the operations of the preceding paragraph can be implemented together with any subcombination of the following features: wherein the operations further comprise receiving voice-dictated data, causing the voice-dictated data to be converted to text, and associating the text with one or more of the media items as a portion of the metadata; wherein the operations further comprise providing a user interface including a user interface control that is user-selectable to conduct the search; wherein the operations further comprise providing a user interface including a user interface control that is user-selectable to share selected media items of the media items with another user; wherein the operations further comprise providing a user interface including a user interface control that is user-selectable to cause selected media items of the media items to be printed; and wherein the metadata includes color information about at least some of the media items.

Certain aspects, advantages and novel features of the inventions are described herein. It is to be understood that not necessarily all such advantages may be achieved in accordance with any particular embodiment of the inventions disclosed herein. Thus, the inventions disclosed herein may be embodied or carried out in a manner that achieves or selects one advantage or group of advantages as taught herein without necessarily achieving other advantages as may be taught or suggested herein.

### BRIEF DESCRIPTION OF THE DRAWINGS

The features disclosed herein are described below with reference to the drawings. Throughout the drawings, reference numbers are re-used to indicate correspondence between referenced elements. The drawings are provided to illustrate embodiments of the inventions described herein and not to limit the scope thereof.

FIG. 1 illustrates an embodiment of a computing environment for implementing an intelligent media management system.

FIG. 2 depicts an embodiment of the media categorization process.

FIG. 3 depicts an embodiment of a media search process.

FIG. 4 depicts an embodiment of a voice tagging process.

FIGS. 5 through 25 depict example user interfaces associated with embodiments of the media management system.

### DETAILED DESCRIPTION

Camera applications store media content in data storage on the mobile device but do not provide any functionality for intelligently searching the content. Consequently, a user typically must scroll through hundreds of pictures or videos to find what the user is looking for. Likewise, media uploaded from a camera to another device (such as a desktop computer) is difficult to search efficiently, even with modern desktop media applications.

This disclosure describes embodiments of an intelligent media management system that can facilitate more organized storage of media, including photos and video. The system can be a platform that sorts camera content into micro groups based on sets of comparable photos, where the groups can be defined by event, sequence, people, actions, context, or other criteria. The system can include back-end technology created for the intelligent recalling of specific images (algorithms and intelligent processing) and a front-end application that delivers this data to the consumer user (e.g., an application or app). The front-end application can include a search engine that enables the user to search the micro-groups to find relevant photos and video more quickly than is possible with currently-available camera applications.

The embodiments described herein apply to any content captured by a user device, including photos, video, and even audio captured by a user device (such as by a dictation application running on a user device). For convenience, however, this specification is described primarily with respect to photos, although it should be understood that references to photos may equally apply to other forms of content, such as video and audio.

This disclosure describes various example embodiments. The designs, figures, and description are non-limiting examples of some embodiments of the inventions described herein. Other embodiments may or may not include the features disclosed herein. Moreover, disclosed advantages and benefits may apply to only some embodiments and should not be used to limit the scope of the inventions described herein.

### I. Example Computing Environment

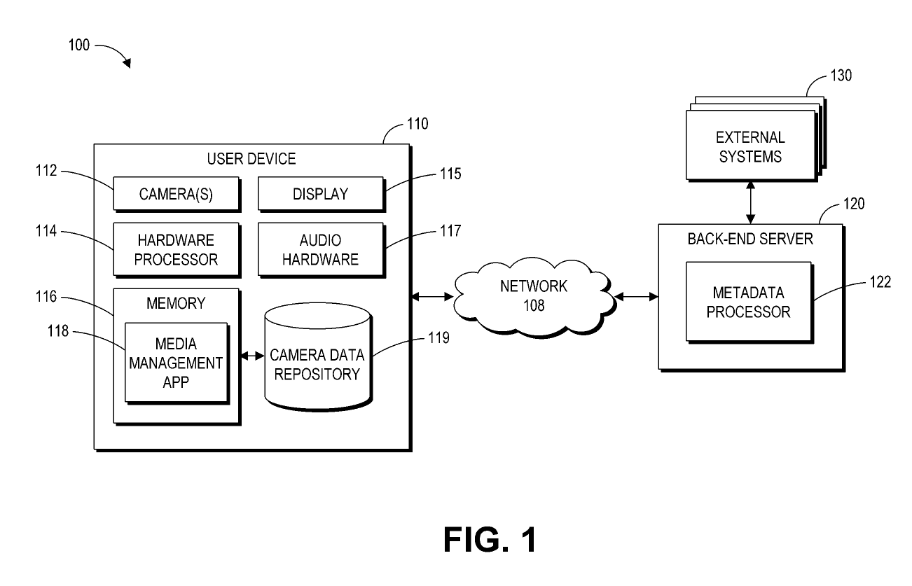

Referring to FIG. 1, an example computing environment 100 is shown for implementing an intelligent media management system. The computing environment 100 shown includes an example user device 110, a network 108, a back end server 120, and external servers 130. The intelligent media management system can include aspects of the user device 110 and the back-end server 120. Advantageously, in certain embodiments, the user device 110 includes a media management application or application 118 that communicates with the back-end server 120 to coordinate intelligent management of media. As a result, in certain embodiments, a user of the user device 110 can more easily find photos (or videos etc.) by browsing or searching within the media management application 118.

The user device 110 can be any mobile device, such as a cellphone, smartphone, tablet, phablet, laptop, netbook, digital camera, smartwatch or swatch, computing-enabled glasses (such as Google Glass™ or the like), or any other wearable computing device or the like. The example user device 110 shown includes one or more cameras 112, a hardware processor 114, memory 116, a display 115, audio hardware 117 (such as speaker(s) and/or microphone(s)), and a camera data repository 119. The one or more cameras 112 (and optionally audio device hardware 117) can capture images, video, and/or audio. The hardware processor 114 can execute applications loaded into the memory 116, including the media management application 118. The media management application 118 can store camera data obtained from a camera, including photos, video, and audio in the camera data repository 119.

The media management application 118 can intelligently organize user photos and other media based on metadata associated with the content. This metadata can include information about the date, time, and/or location at which a photo was taken. In an embodiment, the media management application 118 uploads this metadata to the back-end server 120 via the network 108 (which may be a local area network, wide area network, the Internet, or the like). The back-end server 120 can include a metadata processor 122 that uses the metadata to query one or more of the external servers 130 for additional information that can be used as enhanced metadata for the camera content. The external servers 130 can include web sites or other network applications operated by entities other than a provider of the media management application 118 (or by the same provider). In an embodiment, the external servers 130 can provide services such as weather, geolocation information, and the like. The metadata processor 122 can provide the information obtained from the external server(s) 130 to the media management application 118 as enhanced metadata. The media management application 118 can use the enhanced metadata (as well as optionally the original metadata associated with the content) to facilitate more intelligent user browsing and searching of camera content. Thus, in an embodiment, the media management application 118 can replace (or supplement) an existing camera roll or photo gallery application on the user device 110.

In some embodiments, the back-end server 120 may be omitted, and the media management application 118 can communicate directly with the external servers 130. In addition, the media management application 118 can have other functionality, some embodiments of which will be described in greater detail below and in the attached Appendices. Example user interfaces of the application 118 are also described in the attached Appendices.

### II. Example Processes

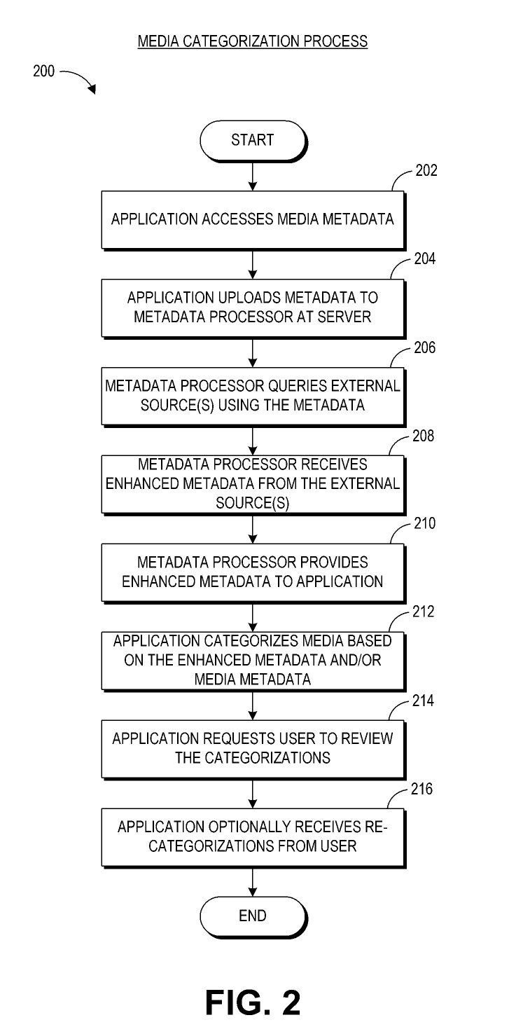

Referring to FIG. 2, an example media categorization process 200 is shown. The categorization process 200 can be implemented by aspects of the computing environment 100 of FIG. 1. Further, the categorization process 200 can be implemented by any computer system comprising computer hardware. For convenience, the process 200 is described in the context of the computing environment 100 of FIG. 1.

At block 202 of the process 200, the media management application 118 accesses media metadata. As described above, the media metadata can include a date and time a picture was taken, as well as the location (expressed in latitude/longitude data obtained from a global positioning system (GPS) device of the user device 110 (not shown)). This metadata may be stored in files that conform to the Exchangeable image file format (Exif) or the like (although other formats may also be used). The Exif files may also include information regarding the aperture size, shutter speed, and the like used by the camera for each photo. This latter information may or may not be used by the application 118.

At block 204, the application 118 uploads the metadata or a portion thereof to the metadata processor 122 of the back-end server 120. The application 118 can upload metadata for one picture (or item of content) at a time or for multiple pictures at a time. At block 206, the metadata processor 122 queries the external servers 130 using the metadata. The metadata processor 122 can use the metadata as keys to query one or more databases on the external servers 130. The metadata processor 122 may, for instance, use web service calls or the like to communicate with the external servers 130. It can be advantageous to upload the metadata to the back-end server 120 instead of the photos themselves in some embodiments, since users' private photos are maintained on their devices and not sent over the network. Further, metadata is typically smaller in size than photos and can therefore consume less bandwidth and be transmitted more rapidly than a photo. Accordingly, the system described herein can operate more efficiently and faster than existing camera roll systems. However, in other embodiments, at least some photos can be sent to the back-end server 120, for example, for processing intensive features such as facial recognition (described below).

The metadata processor 122 receives enhanced metadata from the external servers 130 at block 208 and provides this enhanced metadata to the application 118 at block 210. The application 118, in turn, can categorize the media programmatically based on the enhanced metadata and/or the original metadata at block 212. Example categorizations are described below under the section entitled “Example Use Cases.”

At block 214, the application 118 optionally requests the user to review the categorizations. The user can change the categorizations or accept the categorizations. In an embodiment, this review process is simple and straightforward to avoid taking too much time for the user. For example, the application 118 may output yes/no buttons in response to proposed categorizations. The application 118 may also output a text box for the user to input an alternative categorization. In some embodiments, the application 118 also provides user interface controls to enable a user to delete pictures from or add pictures to a group. At block 216, the application 118 optionally receives re-categorizations from the user.

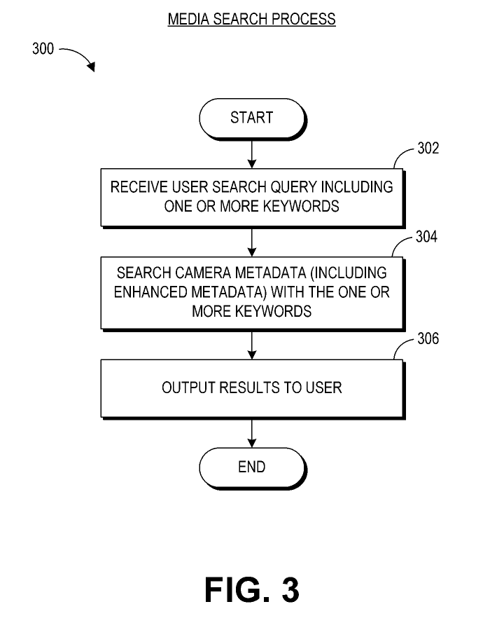

Turning to FIG. 3, an example media search process 300 is shown. The media search process 300 can be implemented by aspects of the computing environment 100 of FIG. 1. Further, the media search process 300 can be implemented by any computer system comprising computer hardware. For convenience, the process 300 is described as being implemented by the media management application 118 of FIG. 1.

At block 302, the application 118 receives a user search query comprising one or more keywords. The user may, for instance, open the application 118 and type in (or dictate using voice recognition software) the search query. At block 302, the application 118 searches the camera metadata, which can include the original metadata associated with an image and the enhanced metadata obtained from the back-end server 120. At block 306, the application 118 outputs the results to the user.

In an embodiment, the user can optionally drill down into categories provided by the search results. The user can also optionally confirm whether the results are accurate to enable the application 118 to further refine the categorizations.

The application 118 can also allow users to add metadata with voice instead of or in addition to typing text. The computing device in which the application 118 is installed may include speech-to-text capability that can convert a user's voice input into text that can be associated with one or more photos. This voice tagging feature can advantageously enable users to rapidly enter text via voice, which the application 118 can use as metadata to associate with one or more photos. The application 118 can later enable a user to search the text to find photos quickly. Who will

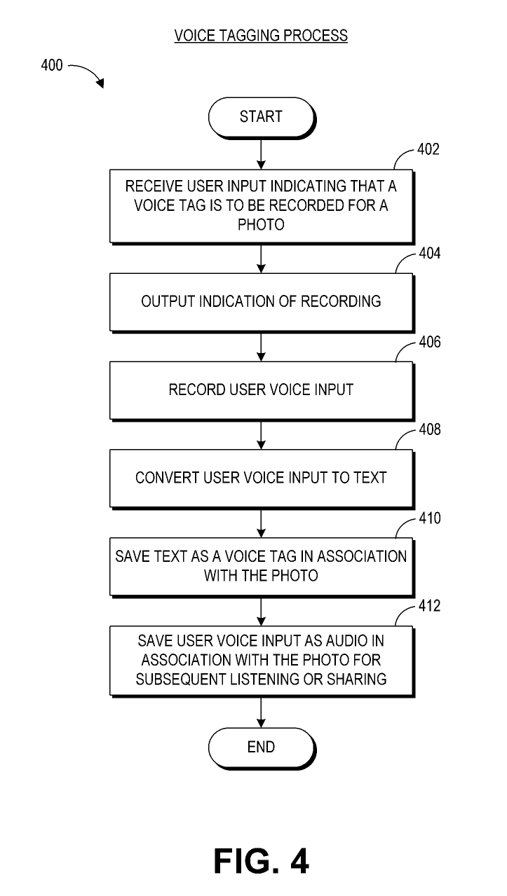

FIG. 4 depicts an example voice tagging process 400. The voice tagging process 400 can be implemented by aspects of the computing environment 100 of FIG. 1. Further, the voice tagging process 400 can be implemented by any computer system comprising computer hardware. For convenience, the voice tagging process 400 is described in the context of the computing environment 100 of FIG. 1.

At block 402 of the process 400, the application 118 receives user input indicating that a voice tag is to be recorded for one or more photos (or video(s)) or a category of photos. For instance, a user may select one or more photos or a category of photos and select an option provided by the application 118 to record a voice tag. The option to record a voice tag may be provided in an options menu. The application 118 may also enable a user to long-press (e.g., depress his or her finger on the screen for a short period of time longer than a mere “tap”) a photo or category to initiate the voice tagging process 400.

Once the user has initiated voice tagging, the application 118 can output an indication of recording at block 404. The indication may be an icon or the like that indicates that recording is occurring or is about to occur. In one embodiment, the application 118 outputs a countdown timer (such as “3, 2, 1”) prior to initiating recording. The application 118 can initiate recording by invoking an appropriate routine in an audio library provided with an operating system of the computing device in one embodiment.

At block 406, the application 118 records the user input, and at block 408, the application 118 converts the user input to text using, for example, a speech-to-text library (such as the OpenEars™ speech synthesis library for Apple™ devices or the android.speech library for Android™ devices). The application 118 saves the text as a voice tag in association with the one or more photos selected by the user at block 410. The voice tag may be visible or hidden from the user. In either case, the voice tag can be searchable as metadata associated with the one or more photos. In addition, the application 118 can later assign the voice tag to other photos that the application 118 determines are similar to the photos to which the voice tag was explicitly assigned by the user. For example, a photo tagged with a voice tag “Heidi's birthday” may have been taken a few minutes earlier than another photo that is not tagged. The application 118 may infer that the second, later photo is also related to “Heidi's birthday” and apply the same tag to that photo.

The application 118 can save the user voice input as audio in association with the one or more selected photos for subsequent listening or sharing at block 412. The user can later listen to the audio. The user can also access sharing features (described in greater detail below) in the application 118 to share the audio with other users. Conversion of the recorded speech to text is optional in some embodiments. Instead of doing so, the audio can merely be recorded for later access by the user or sharing with other users.

In still other embodiments, the application 118 can provide functionality for a first user to chat with other users in the first user's social network, directly within the application. The application 118 can, for instance, allow the first user to chat directly with users with whom the user shared photos. Thus, a user may share photos (see below for more details), and the application 118 may then present the user with the option to chat (via voice or text) with the users that were just sent the shared photos.

### III. Example Use Cases

There are many use cases for the intelligent media management system, a few of which will be described herein. These examples should not be construed to be limiting, but are rather embodiments that can be implemented by the media management application 118 and/or back-end server 120.

In a first example, a user takes ten pictures at an afternoon holiday gathering, such as a 4th of July (Independence Day in the U.S.) gathering. The application 118 can automatically upload metadata associated with each picture to the back-end server 120 as described above. This metadata can include the date, which is the 4th of July, the time the pictures were taken (e.g., in the afternoon), and the location (latitude and longitude). In response, the back-end server 120 can query an external server 130 to determine what location corresponds to the latitude and longitude and may receive an address in return. The back-end server 120 can provide this address to the application 118. The application 118 can query a personal information management (PIM) application on the user device (such as a contacts app) to identify whether the address corresponds with any of the addresses in the mobile phone. In one example, the address corresponds with the user's parents' house in Seattle. The back-end server 120 can also query an external server 130 that hosts weather information with the date and time the picture was taken to obtain the weather for that date and time. The application 118 may then associate the following enhanced metadata with the ten pictures (or the like): 4th of July, raining (for example), at parent's house, and Seattle. The application 118 may also group the ten pictures together as being related and enable the user to subsequently search for these pictures by typing in queries such as “4th of July,” “raining,” and “parent's house,” or “Seattle.” The application 118 or back-end server 120 may also use a thesaurus application (or contact an appropriate external server 130) to look up synonyms of the enhanced metadata terms. The application 118 can then associate not only terms such as “parent's house” with a picture but also “mom and dad's house” or just “mom” or “dad” with the picture.

As another example, the application 118 can query the back-end server 120 to determine whether the time of a photo corresponds generally to breakfast, dinner, or lunch. Alternatively, the application 118 can make this determination by consulting a user's calendar program installed on the user device to determine when the user takes breakfast, lunch, or dinner, etc. The application 118 can associate the appropriate time-based event with photos occurring at that time, such as “lunch photos” or the like.

In another example embodiment, the back-end server 120 can perform a second look-up or query to an external server 130 based on information obtained from a first external server 130 (or a second query to the same external server 130). A first query might include latitude and longitude information and receive an address or physical location in return, such as “the Staples Center” in Los Angeles, Calif. The back-end server 120 may use this location to query an external server 130 to determine what event was happening at the Staples Center at the time the picture was taken. The event returned may be the Clippers™ basketball game. Accordingly, the back-end server 120 may provide this information to the application 118 so that the application 118 can associate “the Staples Center,” “the Clippers game,” or “basketball” with the relevant picture(s).

In another example embodiment, the application 118 accesses calendar information from a calendar app on the user device 110 to determine who the user may have been with at a given time. For instance, the calendar may show an after-hours work meeting scheduled with three work friends. The application 118 can identify a picture taken during the same time as the work meeting and associate the picture with metadata representing the identities of the three work friends. Likewise, the application 118 can obtain the location of the meeting (if available) from the calendar and associate the location with the pictures. Thus, later when the user searches for “pictures I took with Jim at the El Torito restaurant,” the application 118 can find the relevant pictures from the previously-created metadata.

Latitude-longitude data is described above as being translatable into an address. More generally, the latitude-longitude data captured by the user device 110 can be translated or mapped to any location, such as a city, state, country, park, business, street, geographic location (such as the name of a body of water or mountain), or the like. Further, latitude-longitude data can be mapped to nearby businesses or other notable locations. Thus, for example, a picture taken just outside of Yosemite National Park may be associated with the metadata “Yosemite” even though the picture was not taken in the park itself.

The application 118 may also provide user-selectable options for a user to define a zone, boundary, or geofence around locations to enable the user to increase or decrease the number of nearby locations that are captured in the enhanced metadata. For instance, the application 118 may provide a user interface that allows a user to specify whether to capture only exact locations (such as exact address), nearby locations within a few feet, locations within 100 feet, locations within a mile, and so on. These numbers may differ in other embodiments. During the review phase, the application 118 may allow a user to also restrict or enlarge the zone of nearby locations. A user who took pictures at a neighbor's house may, for instance, want the zone of nearby locations to be small to not include the user's own house. Conversely, a user on a site-seeing trip may wish to have a larger zone of nearby locations to capture as many details as possible about the user's surroundings. If the user changes the zone, the application 118 can request updated metadata from the server 120 for some or all of the pictures.

In certain embodiments, when users review photos and make changes to suggested metadata or photo categorizations, the application 118 can upload at least some of these suggested changes to the back-end server 120. The server 120 can maintain a repository of user changes to location names and other metadata. Thus, for instance, if a user indicates that a photo is just outside the “Newport Yacht Club,” the back-end server 120 can use this information for subsequent users in the same or nearby location. The back-end server 120 therefore can use crowd-sourced functionality to enhance the metadata of some or all users of multiple user devices that connect to the server 120.

When users search, users can enter one or more keywords, as described above. Results returned to the user can find the logical “AND” of the keywords supplied by the user in the metadata. In an embodiment, the application 118 depicts a user interface that shows the keywords supplied by the user as buttons on the same display as the search results images. The user can select any of the keyword buttons to refine the search to show only pictures with the selected keyword. Alternatively, the application 118 can treat the search keywords using a logical “OR” to search the metadata.

The application 118 may categorize a plurality of photos into a single group. For example, as described above, ten photos taken on the same day may be grouped into a single group. If the user then reviews one of those photos and updates the metadata for that photo (e.g., by specifying a location), the application 118 can automatically add the same location to the rest of the photos in the group. Similarly, when categorizing photos, the application 118 can initially categorize photos based on the initial metadata (such as by identifying all pictures taken on one day) and then upload a representing sample (one or more) of the photos to the back-end server 120 to obtain enhanced metadata for all the photos in the initial categorization.

The application 118 may also provide functionality for users to tag individuals and objects within a picture to further add metadata to a photo. A user may add individual's names to the photo with such tags, for instance. In some embodiments, the application 118 also includes facial recognition software that automatically recognizes faces of individuals in an image and tags the image accordingly with the individuals' names. The facial recognition software in the application 118 may include one or more application programming interface (API) calls to the back-end server 120, which performs the actual facial recognition analysis using a commercially available algorithm. The facial recognition software may use user-tagged images to seed the facial recognition algorithm. For example, if a user tags a certain individual with the name “Mike,” the facial recognition software can then look for other similar faces in other photos and tag those photos with the name “Mike” as well. As with other metadata provided by the application 118, the metadata provided by the facial recognition software can be reviewed and edited by the user. The facial recognition software can learn from the user's revisions and improve its algorithm accordingly.

More generally, the application 118 can include or communicate with image recognition software that can recognize not only faces but also optionally other objects or images as well, such as a “dog,” “plate of food,” “snow,” and so on. The image recognition software may be implemented on the user device or in a remote server that uses commercially-available algorithms such as machine learning or neural networks to identify images. For instance, in an embodiment, the application 118 can upload an image to the server, the server can use the image recognition software to identify one or more objects and/or people in the image, and the server can send metadata regarding the detected objects back to the application 118.

More generally, the application 118 can learn from any user revisions to metadata or categorizations proposed by the application 118 and adjust future metadata or categorization assignments accordingly. Further, the application 118 may categorize images in multiple categories. A single image of a friend at an outdoor birthday party, for instance, may be categorized in any of the following categories: pictures with “friend,” pictures outside, birthday pictures, pictures at (location of the party), and so on.

The application 118 and/or back-end server 120 can make pictures available for sharing via social networks, photo printing and drop-shipping facilities, and the like. For instance, the application 118 can include a folders feature that groups photos into folders based on any of the categorizations described herein. The application 118 can share any folder via communication to a friend of the user or to the user's entire social network (or any subportion thereof). The application 118 can provide functionality for the user to manually request a folder to be shared, or the application 118 can automatically share folders. The application 118 can also allow the user to mark a folder as personal or private so that it is not shared with others. Any of the sharing features described herein can also apply to individual photos instead of folders. In addition, any folder can include one or more subfolders.

In some embodiments, the application 118 can suggest other users to share folders or photos with. The application 118 can, for instance, identify a user in a photo (using any of the techniques described elsewhere herein) and recommend to the user of the application 118 that the folder or photo be shared with that identified user. For instance, if the application 118 identifies that three photos were taken on the same day at the same time that the user's calendar application says that the user had a lunch meeting with John, the application 118 can group the three photos into a “John” folder and recommend that they be shared with John. The more information the application 118 obtains about the user, the user's social network, and the user's photos, the more intelligent recommendations the application 118 can make for sharing those photos. More generally, the more information provided to the application 118 about the user and/or the user's social network and/or photos, the more intelligent decisions the application 118 can make about categorizing photos or performing any of the other features described herein.

The back-end server 120 can provide credits or the like that a user can spend for printing services. Users can purchase credits through the application 118 or a website hosted by the back-end server 120 or can obtain credits for free by sharing the application 118 with other users or by performing other activities. Further, the back-end server 120 can organize picture contests among users (e.g., for users to photograph certain items or locations that the back-end server 120 automatically identifies as being correct or not) to promote or obtain credits. The back-end server 120 may also supply information about products or locations photographed by users to consumer goods companies or other businesses to facilitate targeted marketing efforts. Users can opt-in or opt-out of such marketing analysis.

In an embodiment, users can share photos directly within the application 118 by sending photos to another user's device. When the second user receives the photos, a copy of the application 118 installed on the second user's device can organize and categorize the photos automatically and enable the second user to review the photo categorizations. If the second user's device does not include a copy of the application 118, the message containing the photos can prompt the second user to download a copy of the application 118.

Although the back-end server 120 is described as enhancing the metadata and sending the enhanced metadata to the application 118, the back-end server 120 may retain the enhanced metadata in an embodiment. In response to a search request, the application 118 can send the search request to the server 120, which can search the enhanced metadata and return results to the application 118. Alternatively, as described above, the back-end server 120 is not used, and the application 118 creates enhanced metadata and searches the enhanced metadata. thus, some or all of the features of the server 120 may be implemented by the application 118 in other embodiments.

### IV. Example User Interfaces

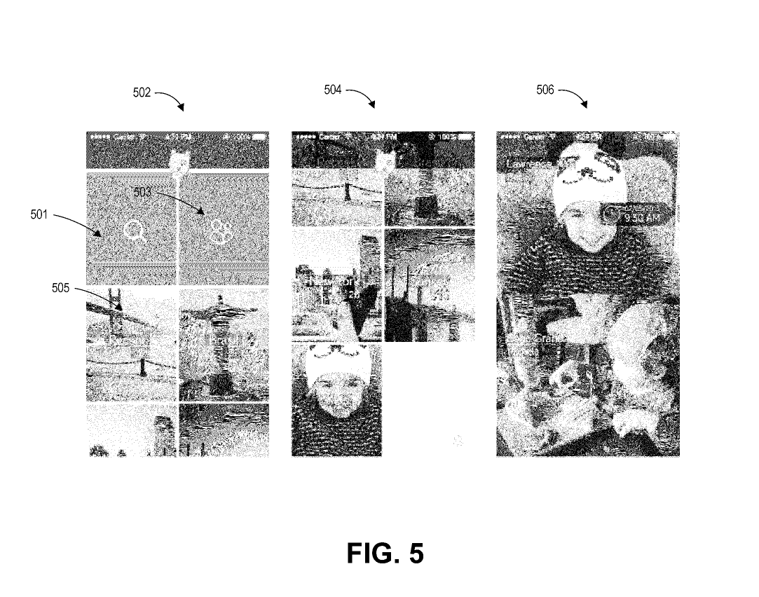

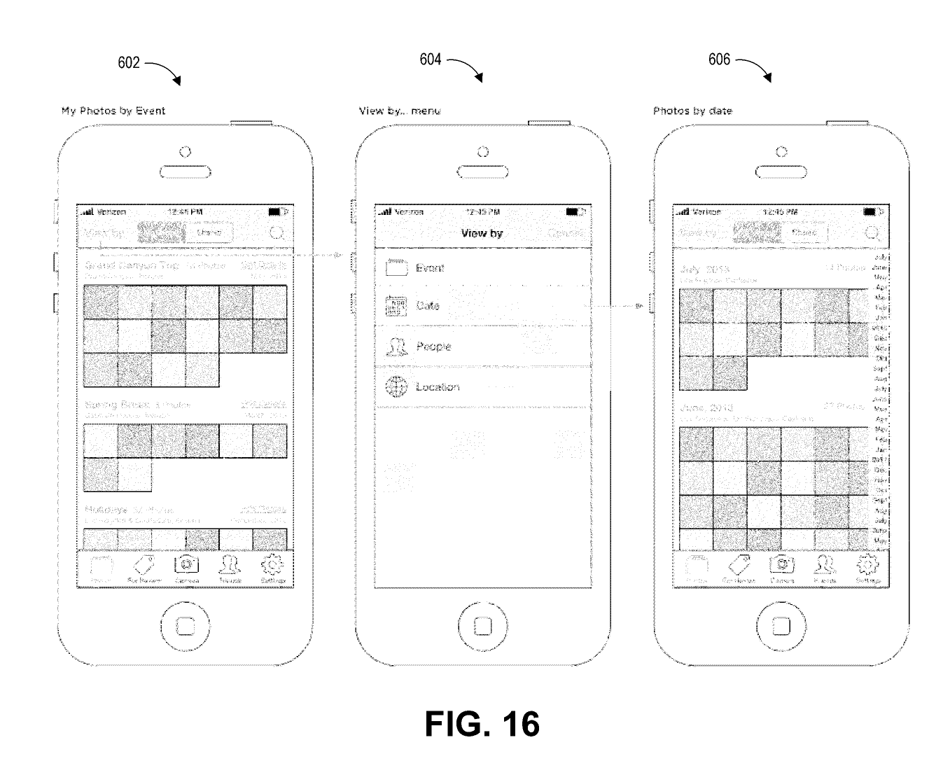

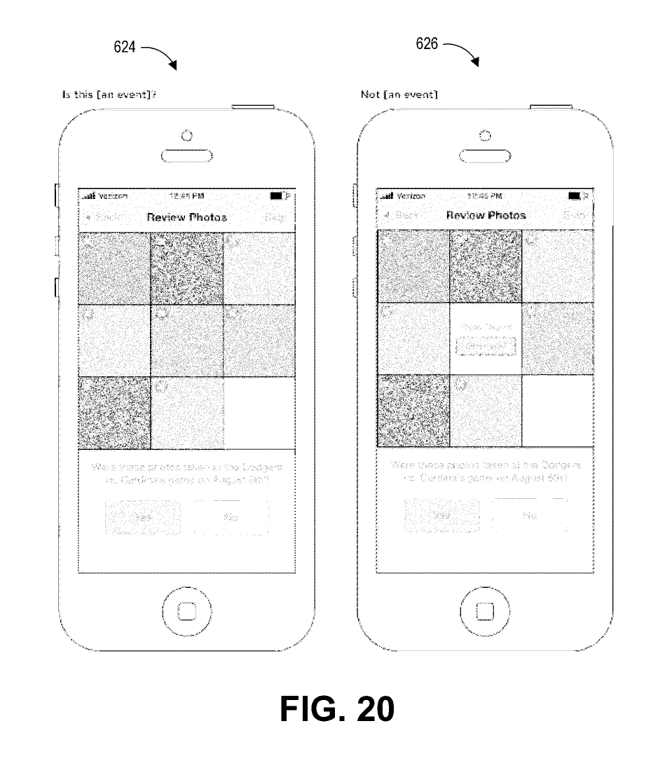

FIGS. 5 through 25 depict example mobile device user interfaces that can implement a variety of the features described herein. These user interfaces include features for categorizing media, searching media, sharing media, ordering prints of media, and the like. In general, the user interfaces shown or described with respect FIGS. 5 through 25 can provide any of the user interface functionality described above or elsewhere herein. FIGS. 5 through 15 depict a set of interfaces corresponding to one version of the application 118, while FIGS. 16 through 25 depict another set of interfaces corresponding to another version of the application 118 (which may be used together with the version shown in FIGS. 5 through 15). FIGS. 5 through 15 show the interfaces separate from any particular device and can be used with any type of computing device, such as a phone, tablet, laptop, desktop, or the like. FIGS. 16 through 25 show the interfaces in an example phone for illustration purposes but could also be used with any other type of computing device.

Each of the user interfaces shown includes one or more user interface controls that can be selected by a user, for example, using a browser or other application software. Thus, each of the user interfaces shown may be output for presentation by the application 118, which may optionally include a browser or any other application software. The user interface controls shown are merely illustrative examples and can be varied in other embodiments. For instance, buttons, dropdown boxes, select boxes, text boxes, check boxes, slider controls, and other user interface controls shown may be substituted with other types of user interface controls that provide the same or similar functionality. Further, user interface controls may be combined or divided into other sets of user interface controls such that similar functionality or the same functionality may be provided with very different looking user interfaces. Moreover, each of the user interface controls may be selected by a user using one or more input options, such as a mouse, touch screen input, game controller, or keyboard input, among other user interface input options. Although each of these user interfaces are shown implemented in a mobile device, the user interfaces or similar user interfaces can be output by any computing device, examples of which are described above. The user interfaces described herein may be generated electronically by the application 118 or the back-end server 120 described above.

FIG. 5 depicts three example interfaces 502, 504, and 506. In the interface 502, a search button 501 is shown, and a share button 503 is shown. Further, groups 505 of different pictures (or other media) are shown, including a group organized under the tag “Recent” and another group of pictures organized under the tag “Brasil.” The user could select the search button 501 to search for photos and could select the share button 503 to share photos with friends. A user can scroll down in the interface 502 to be presented with the interface 504, which shows additional groupings of photos based on the tags “New York,” “Sunset,” and “Kids.” User selection of the “Kids” group of photos can result in outputting the interface 506, which depicts photos within the “Kids” group.

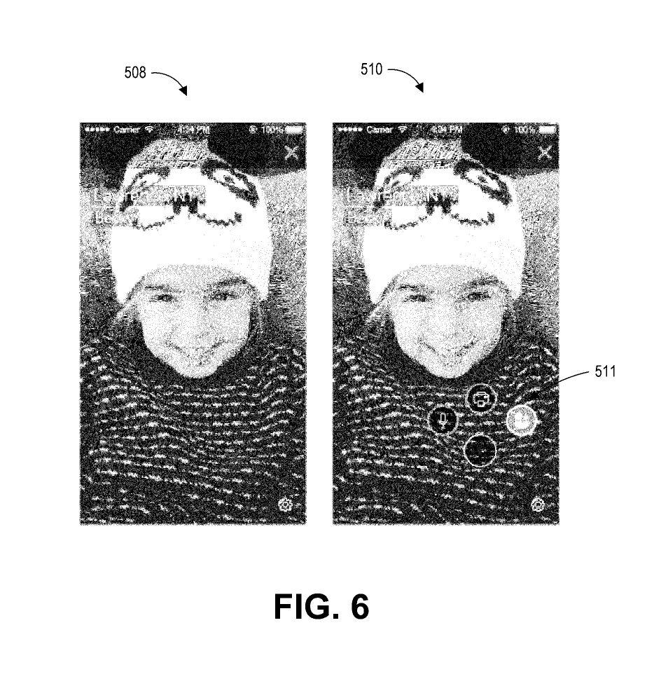

User selection of one of the photos in the interface 506 can cause the application 118 to output the interface 508 of FIG. 6. The interface 508 depicts a particular picture and includes metadata text (“Lawrence, NY” and “Becky”) the user may have used to tag the picture or which the application 118 may have tagged the picture with automatically. A long press or other selection action performed on the interface 508 by a user can result in the application 118 outputting the interface 510. Icons 511 are shown on the interface, which have appeared as a result of the user selection action. These icons 511 include a microphone icon, a printer icon, and a friends icon. The friends icon 511 is highlighted, indicating that the user has just selected the friends icon. Selection of the friends icon 511 can cause the application 118 to output a user interface for sharing the photo with one or more other users. Selection of the microphone icon 511 can cause the application 118 to output a user interface for dictating a voice tag. Selection of the printer icon 511 can cause the application 118 to output an interface that facilitates printing the picture at a brick-and-mortar or online store.

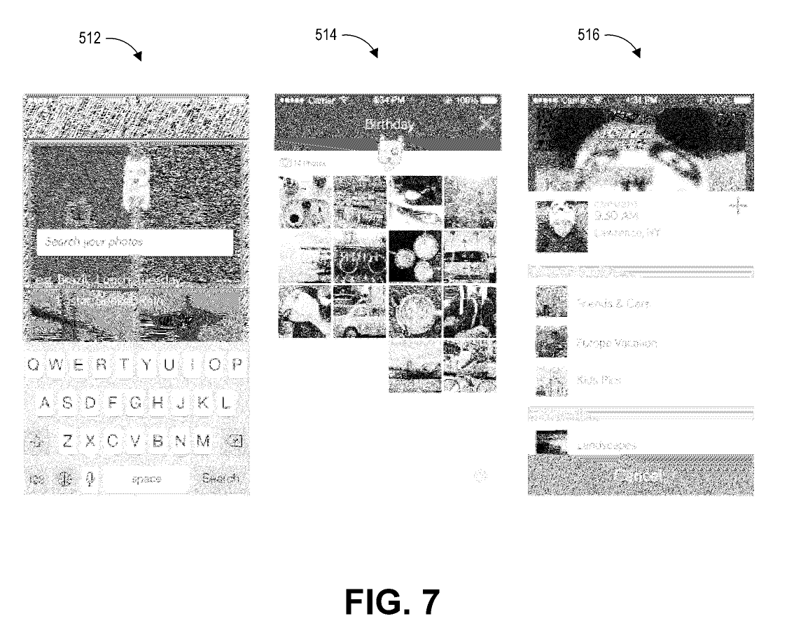

Turning to FIG. 7, an interface 512 is shown for searching photos in a user's camera roll. Upon a user entering example text such as “birthday” and performing a search, a user interface such as the interface 514 may be presented to the user by the application 118. The interface 514 includes a list of photos that match the text “birthday” in their metadata or using another algorithm described elsewhere herein. The interface 516 depicts recent boards or categories accessed by the user as well as other boards or categories of media.

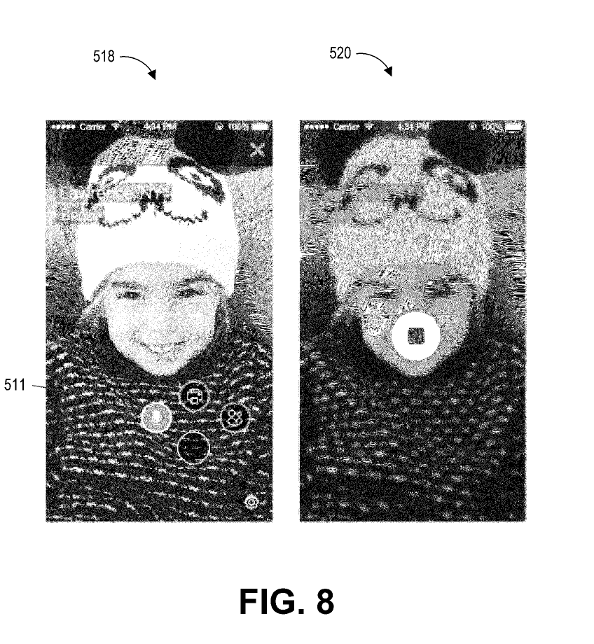

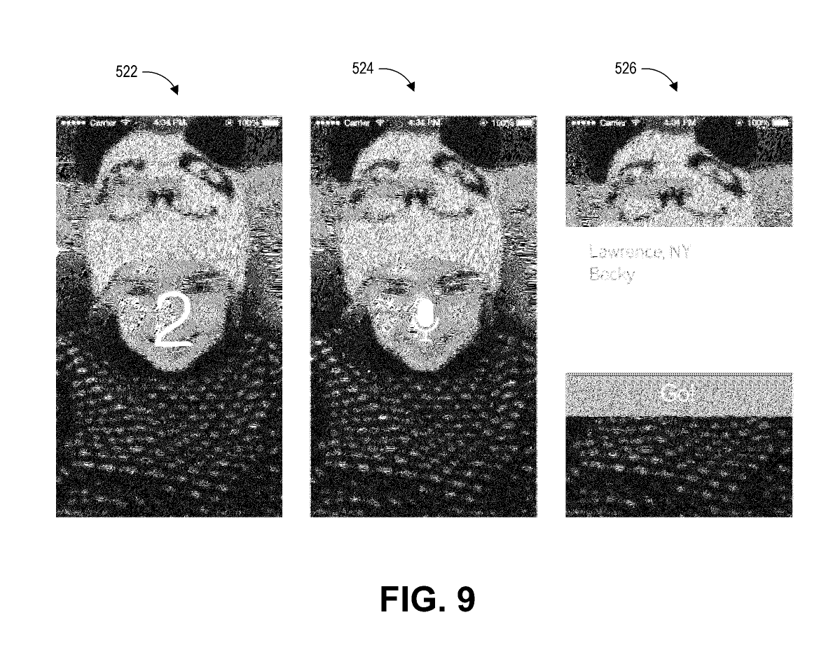

FIG. 8 again depicts the icons 511 in an interface 518. The microphone icon 511 is selected in the interface 518. As a result of this user selection, the interface 520 is shown, indicating that the microphone of the user device is currently in use to record a voice tag about to be dictated by the user. The user can select to stop button shown on the interface to stop the recording. FIG. 9 shows an interface 522 that begins a countdown to when recording will actually take place, and interface 524 shows a microphone icon to indicate the recording is taking place. An interface 526 shows the text that is been transcribed by the voice transcription software accessed by or integral with the application 118 (or in the backend server 120) as well as a “go” button that the user can select to apply the text to the image as a tag.

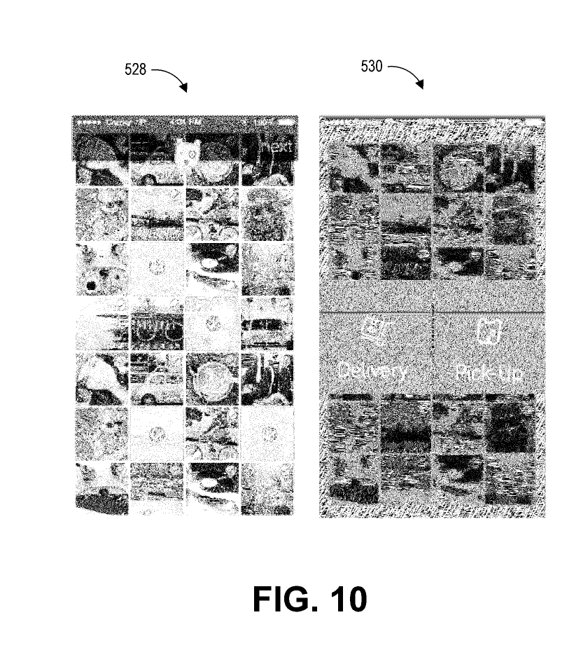

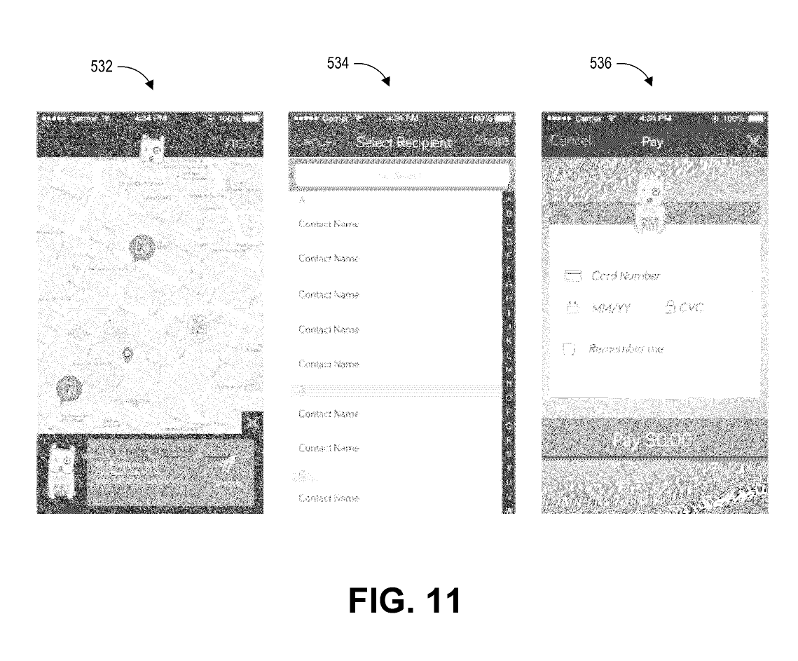

As described above with respect to FIG. 5, a user can select the share button 503 or share icon 511 in other interfaces to share pictures or to print pictures for delivery or pickup. In FIG. 10, a user can be presented with the interface 528 when requesting to print pictures. A number of pictures are shown selected in the interface 528. Upon selection of the “next” button in the interface 528, the application 118 can present the user with an interface 530 which provides buttons for selecting the printouts to be delivered to the user (or one or more of the user's contacts) or for the user or others to pick up the printouts at some location. FIG. 11 depicts an interface 532 where the user can pick up the printed pictures. An interface 534 shows search functionality for identifying and selecting one or more contacts to be recipients of the pictures for delivery. An interface 536 provides payment options for paying for the printing of the pictures and optional delivery thereof.

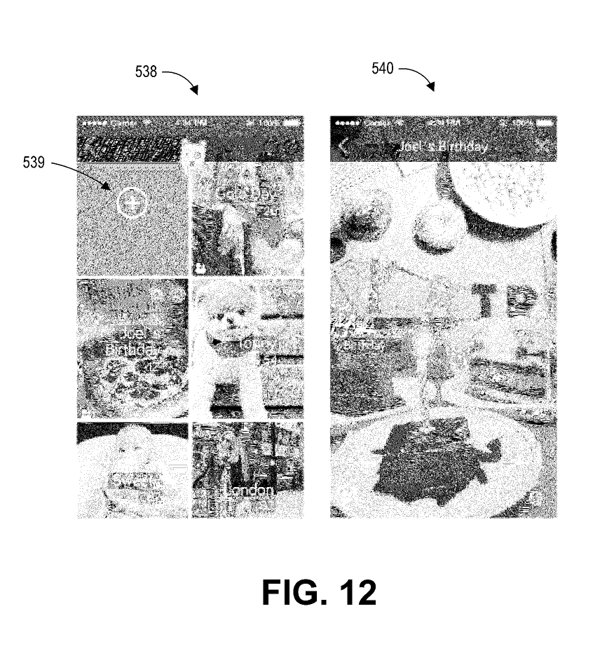

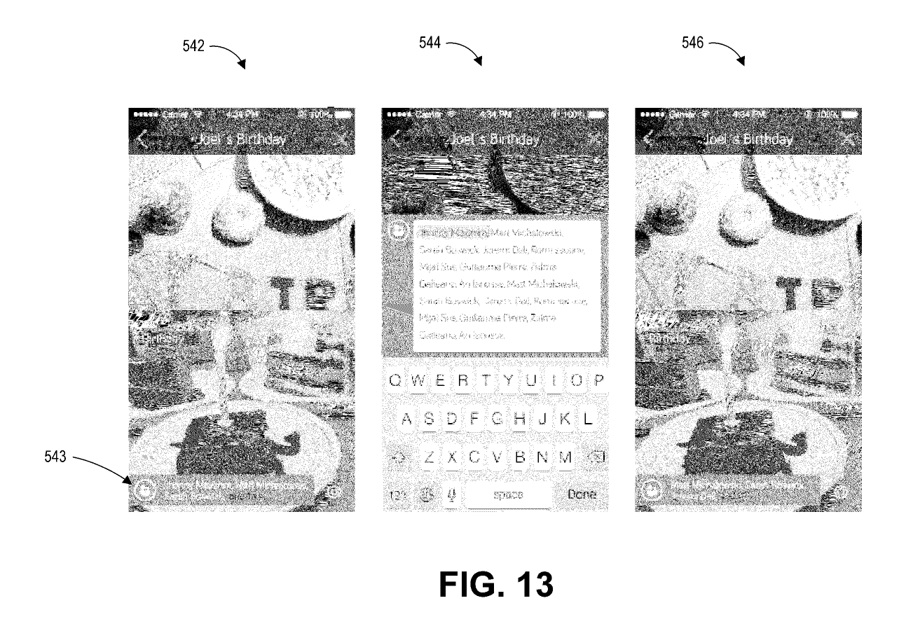

In FIG. 12, an interface 538 of the application 118 shows another example set of categories or boards of different media, along with a button 539 for adding a new category. An interface 540 depicts a few example pictures from an example “Joel's birthday” category or board. In FIG. 13, an interface 542 is shown similar to the interface 540, which also includes a list 543 of people or contacts that have been tagged on one of the photos. User selection of the list enables editing of the list as shown in an interface 544. Editing of the list can result in the application 118 returning the user to the same interface 542 but with the updates to the list shown as in interface 546.

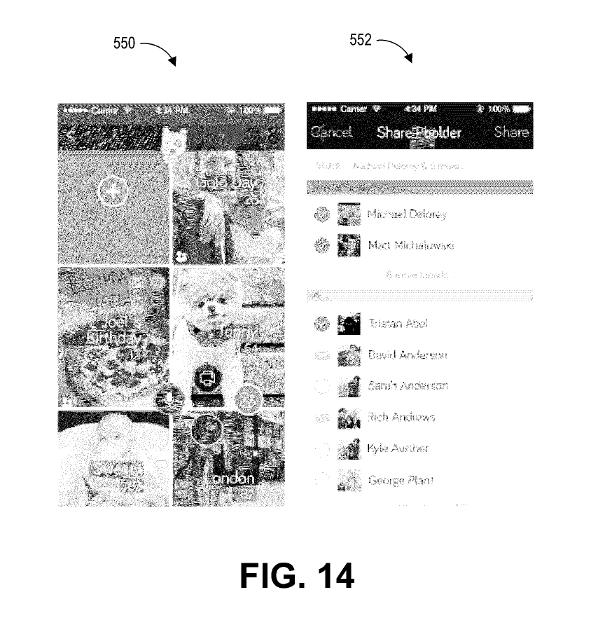

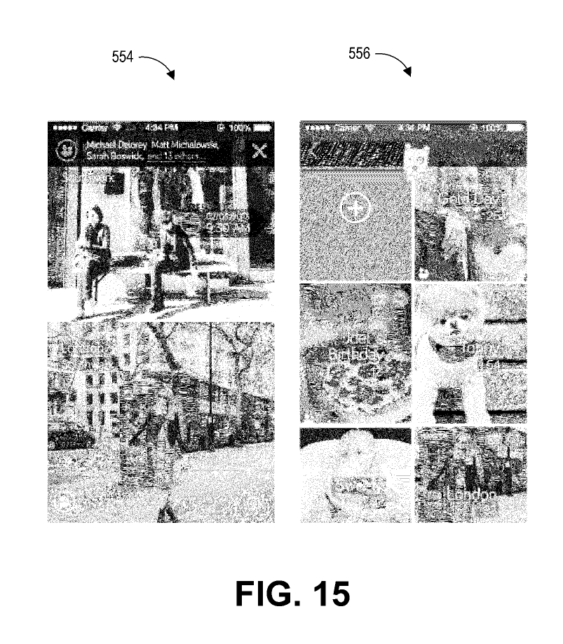

FIG. 14 depicts an interface 550 that is similar to the interface 538 except with the icons 511 shown. In addition, an interface 552 is shown for sharing one or more of the categories or folders (spelt “pholders” in the interface 552). A list of users is shown in the interface 552, which users have been selected for sharing one of the folders. In FIG. 15, photos from a folder that have just been shared with users listed at the top of the interface are shown in an interface 554. Another version of an interface 556 similar to the interface 538 is shown, which may be reached after the sharing action is completed with respect to the previous interface.

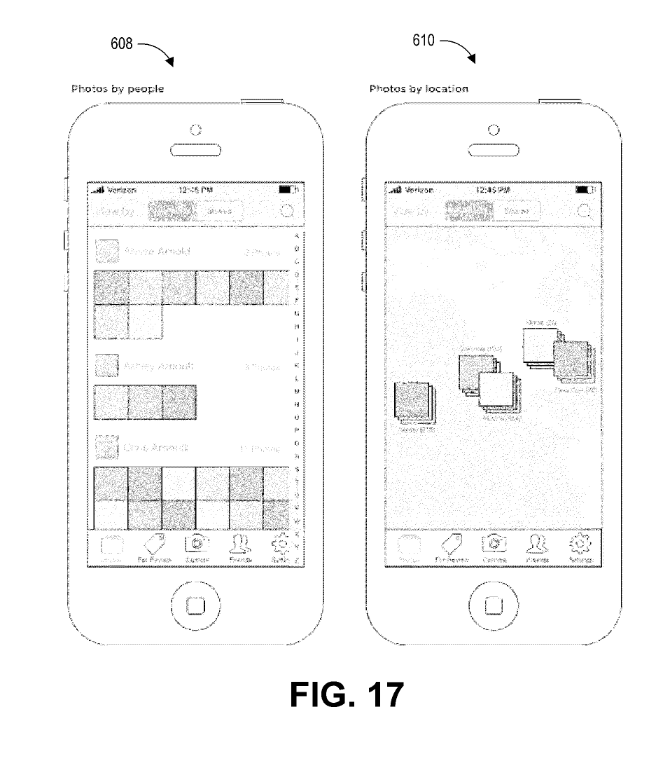

In FIG. 16, an interface 602 is shown that organizes photos according to events. As used herein, the terms event, folder, pholder, category, group, and board are often used interchangeably. Also shown is an interface 604 that allows media to be viewed by event, date, people, or location. An interface 606 is shown that depicts photos by date. Similarly, in FIG. 17, an interface 608 is shown that organizes photos by people, and in interface 610 is shown that organizes photos by location (e.g., the location where the photos were taken or as tagged).

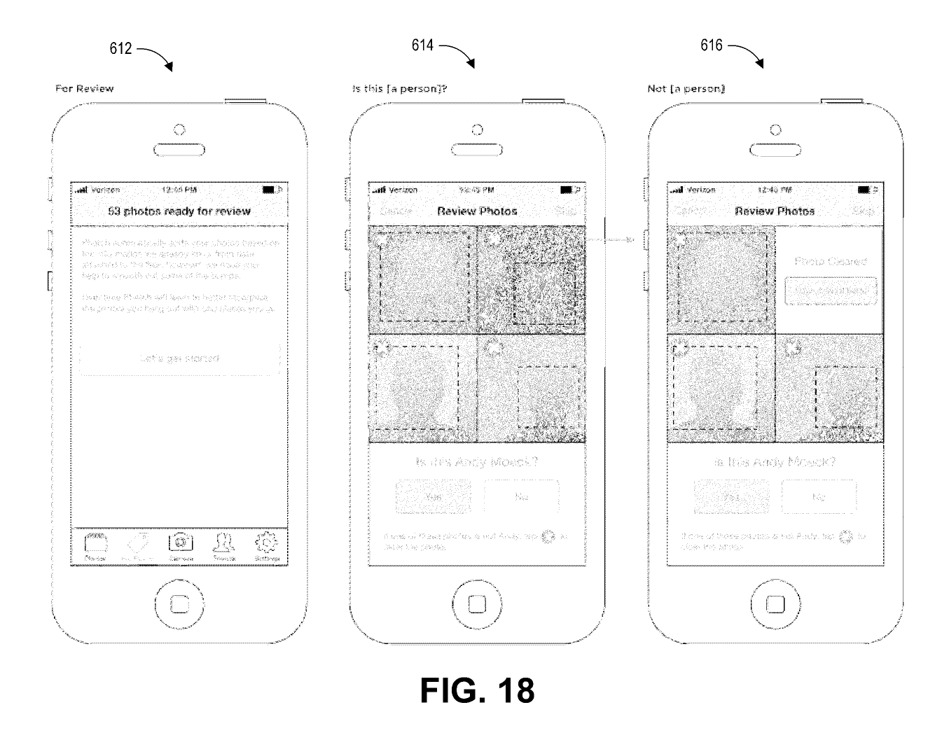

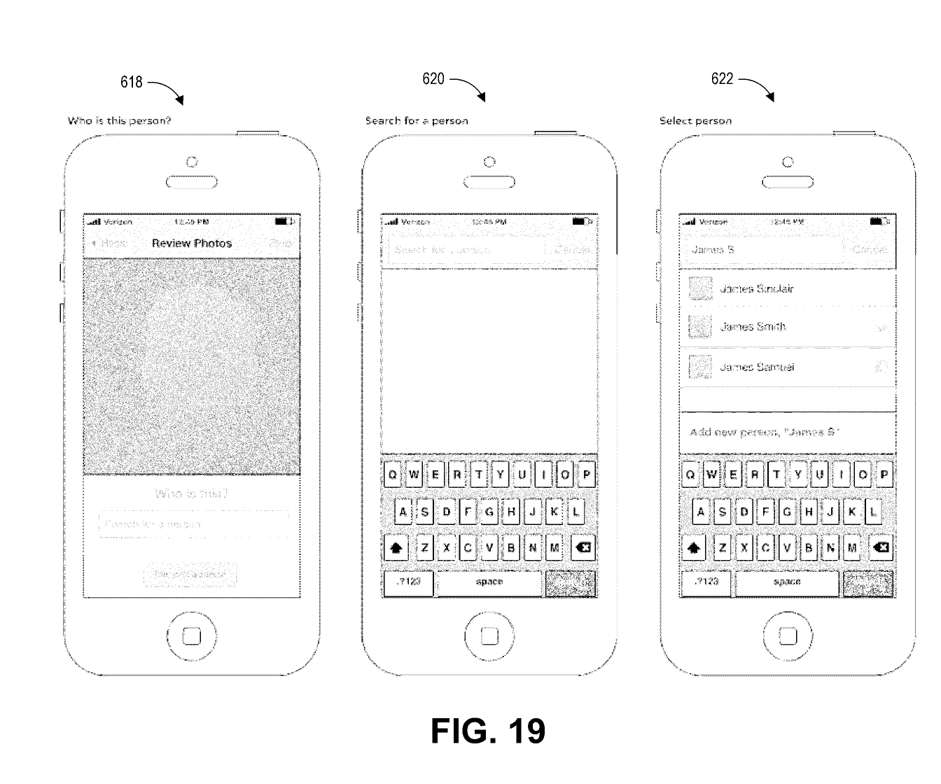

In FIG. 18, in interface 612 is shown that outputs photos for a user to review and tag. Interfaces 614 and 616 allow the user to tag photos based on facial recognition software. The facial recognition software, as described above, can detect faces in the photos and automatically tag or suggest tags for the photos based on the output of the facial recognition software. The interfaces 614 and 616 provide functionality for confirming the accuracy of the facial recognition. If the facial recognition is not accurate or does not output any possible contacts, the interfaces in FIG. 19 may be shown. In the interfaces 618, 620, and 622, a user can search for a person from the user's contacts to tag a picture with.

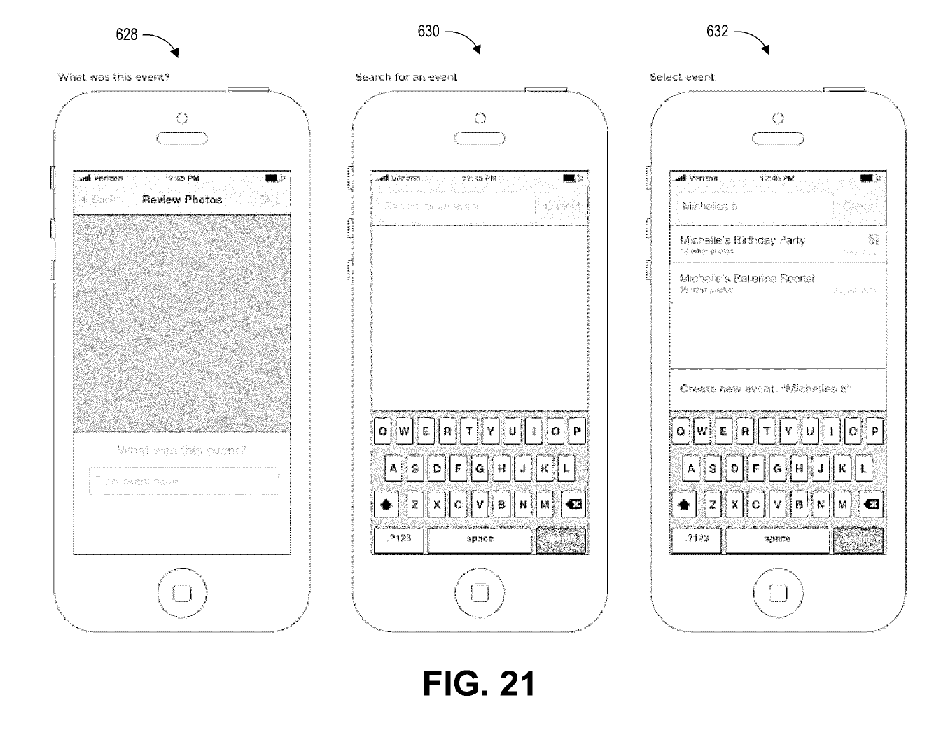

In FIG. 21, an interface 628 is shown for specifying an event to tag a picture with, such as a “birthday” or the like. In an interface 630, a user can search for an existing event that the user has already created or which the application 118 has already specified. The results of an example search are shown in an interface 632. The user can select one of the results of the search to tag a photo with the event to thereby categorize the photo into a folder or the like.

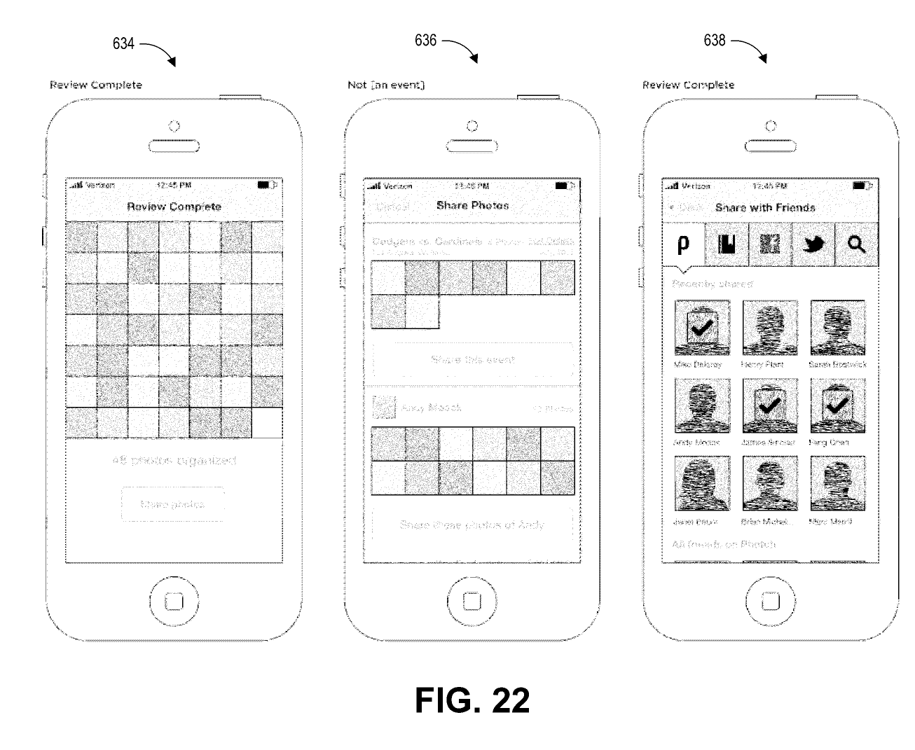

Turning to FIG. 22, an interface 634 may be displayed when a user review (or application 118 review) of recent pictures is completed and the recent pictures are categorized. An interface 636 depicts additional categorizations of photos based on events and options for sharing the photos or an entire folder. An interface 638 depicts options for sharing an event or folder of pictures or other media with one or more users, such as a subset of the contacts in the user's device.

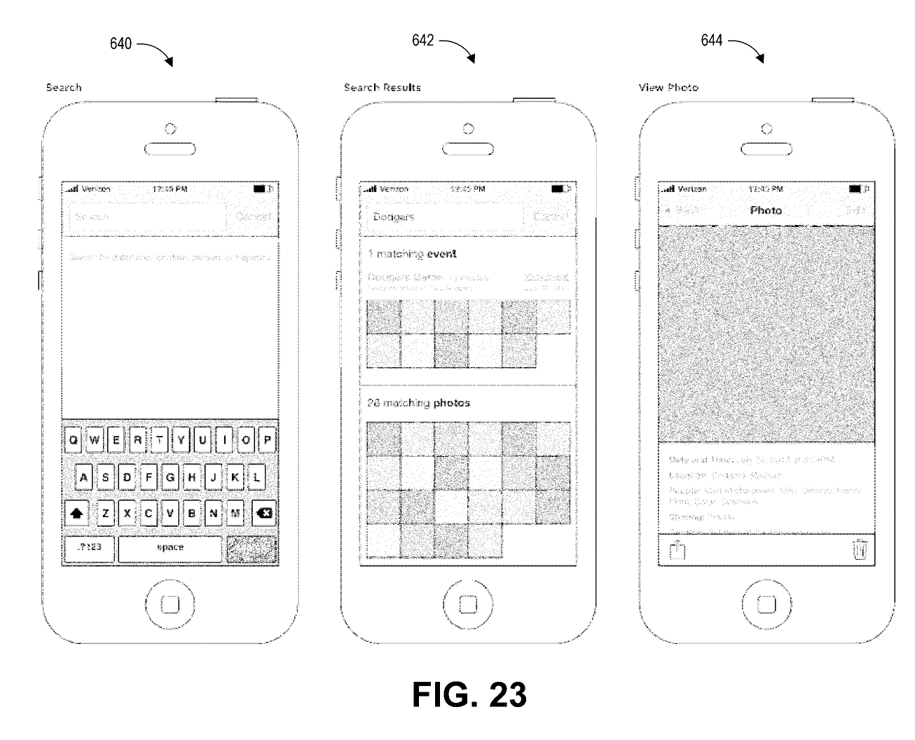

FIG. 23 depicts an interface 644 that enables a user to search for photos based on keywords. Search results are shown in an interface 642, including a matching event and several matching photos. User selection of one of the photos can resulted in output such as the interface 644, which can depict the photo as well as metadata associated with the photo such as time and date, location, people associated with the photo, and so forth.

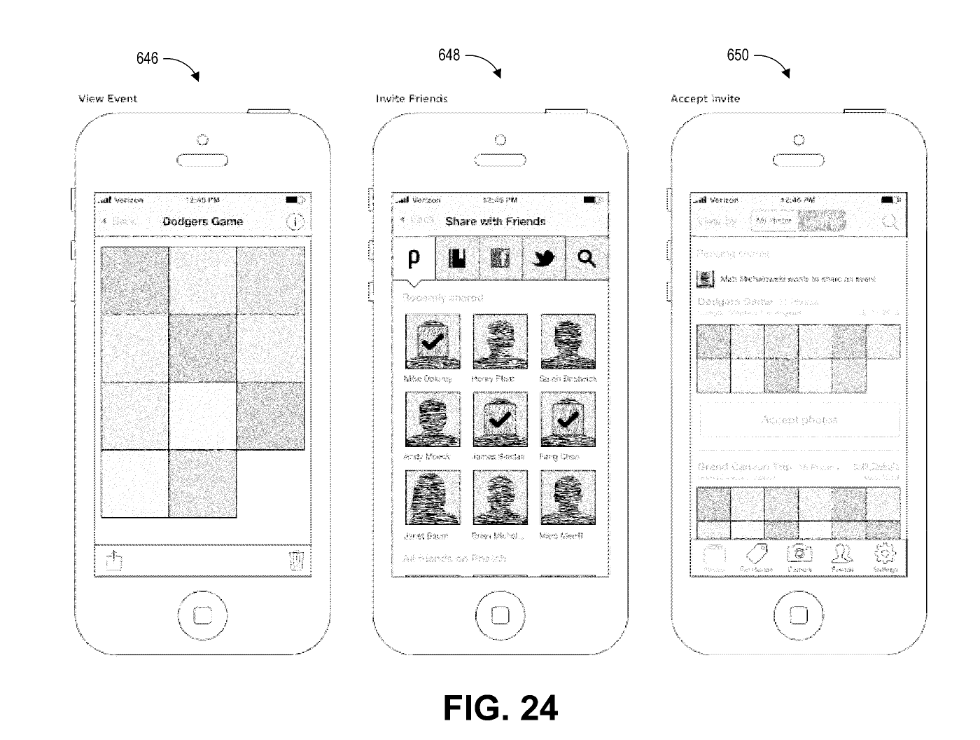

FIG. 24 depicts a user interface 646 that allows a user to view photos associated with a particular event or folder. A user interface 648 provides functionality for a user to invite friends to view that particular event or folder. And a user interface 650 provides functionality for a user to accept the invite to view a shared event or folder.

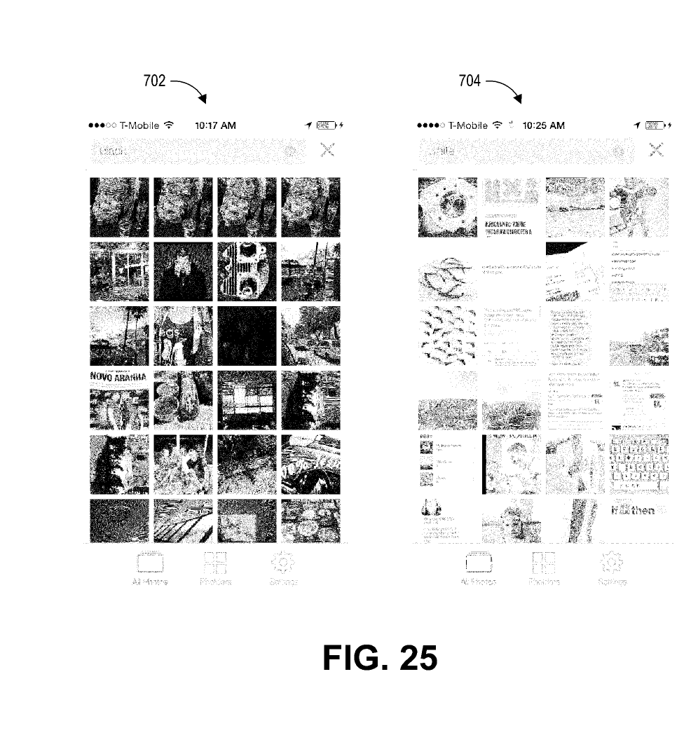

FIG. 25 depicts user interfaces 702, 704 that illustrate embodiments of color-based searching. The application 118 and/or the backend server 120 can perform color-based searches of media. As shown in the interface 702, a user has typed in the search term “black,” and pictures with black content are shown. In the interface 704, the user has typed in the search term “white,” and photos with white in them are shown. The application 118 or backend server 120 can search for a color in one embodiment by looking for a number of pixels or percentage of pixels in the media that exceed a threshold, such as 50% of total pixels in the picture or some other value. In one embodiment, the application 118 and/or the backend server 120 analyzes each media item to determine its color content and stores that information together with other metadata about the item. For instance, if a threshold amount of the color black is contained in a photo, metadata can be stored indicating that the photo is black (or contains black). Color searching can be performed together with other metadata-based searching described herein. For instance, a user might query for media that shows “Jim's blue sweater” or the like and receive relevant media in response.

### V. Additional Embodiments

The application 118 is described above as being implemented on a user device that also takes photos and/or video. In other embodiments, the application 118 can be implemented on a device separate from the device that captures the media. A user may, for instance, upload media from a camera or other mobile device to a second user device such as a desktop, laptop, tablet, or the like. The user may store the media on the second user device or even in cloud storage (using a client such as Dropbox™ or the like). The application 118 may be implemented on the second user device to enable the user to intelligent search for media that is stored on the second user device or in cloud storage.

Thus, for example, a user that uploads pictures from a digital camera to a desktop or laptop computer for editing may wish to intelligently search those pictures on the desktop or laptop. With the application 118 installed on the desktop or laptop, the user can search the pictures using any of the features of the application 118 described above.

In certain embodiments, the application 118 can include a data analysis and retrieval platform using various algorithms to replicate how the human mind stores and retrieves data. The end result can be a platform that can take a set of photographic imagery (or other media) and sort into micro groups based on sets of comparable photos, where the groups are defined either by event, sequence, people, actions or context.

The application 118 can communicate with back end technology (e.g., server 120) created for the intelligent recalling of specific images (algorithms and intelligent processing), and the front-end application 118 can deliver this data to the consumer.

Algorithms & Intelligent Processing

Defining Context: The application 118 can take an entire data set of photographic imagery (or other media) and can recall micro groups based on the manner the human or use case chooses to define, retrieve or remembers. The recall can be mathematical or natural English language, and the application 118 can be built to allow any number of intelligent protocols for the clustering and bringing to front large volume of imagery (or other media) based on the query.

Application of The Intelligence: The application of intelligent retrieval and grouping may have applications in a variety of environments. The proof of concept can be within the consumer market, developing a front-end application (e.g., the application 118) which can provide a user with a large set of imagery (or other media) a better way to recall images vs. currently-available organizational methods. Folders, categories, and file manager application of imagery (or other media) is not how a user remembers a photo, and therefore the application 118 can place some or all photos in a large cluster which may then be narrowed as a specific call to find a photo is defined.

One potential application of this technology to take a large cluster of imagery (or other media) and present micro groups based on the needs of the business can allow the same query management as the user application but in addition the usage of sentiment analysis, more complex activity analysis and attribute recognition of logo or other specific pre-defined data. This can allow an organization in real time or historic form to pull image sets that match their specific needs. Its application can be for commercial organizations, news organizations, and the like.

EXAMPLE HUMAN USER CASE: A user may remember a photo taken in San Francisco with a bridge in the background at sunset with the user's friend Fred at some point last year. In one embodiment, the application 118 takes some or all the custom thoughts the user has represented (e.g., via text or audio) and starts bringing forward imagery (or other media) using positive based algorithms to find specific data in a photo and/or negative based algorithms to remove data that is not relevant, eventually providing a set of images with a high degree of accuracy that meets the user's specified conditions.

The natural language expression of the above user's query might occur in the following fashion:

TABLE 1

| POSITIVE | NEGATIVE |
|---|---|
| Sunset is generally between the hours of | Sunset is never between the hours of |
| 4pm and 8:30 pm during the year in San | 10 pm and 4 pm during the course of a |
| Francisco | year. |
| San Francisco can be defined as the city | Greater than 45 m of the central point of |
| and outer lying areas. | San Francisco is not relevant. |
| Last year is any time between 12:00 | Last year is not any other year than 2012 ± |
| January 1^{st} 2012 and 12:00 December 31^{st} | leniency of time. |
| 2012 | e.g./New Year's Eve |
| DEFINE BRIDGE as a tracked asset and | Photos taken inside a premise, with |
| sequence all images that have the asset in | mountains or dead landscape behind can |
| the photo. | be excluded. |
| All photos that specifically recognize Fred, | Photos with no more than one person, or |
| or white males, or white males wearing | one person plus a female, or one person |
| glasses, or white males with black hair or | and another with an age less than 15 can |
| a baseball cap. | be excluded. |

In certain embodiments, the use of both positive and negative data when running a query not only delivers a quicker results but also a greater chance of a more accurate result when there are “unknowns”

EXAMPLE BUSINESS USE CASE: A user may be seeking all imagery (or other media) featuring happy people in front of a McDonalds logo. The application 118 can classify the logo as an asset and run the same sequencing as the above user example to define photos that include such an asset. In addition, the query can identify people that have facial or activity expressions that represent good mood or greater (thus including laughing, smiling, singing, dancing, sports) to produce a set of images.

PERCENTAGE WEIGHTING & +/− ANALYSIS: In one embodiment, a key to imagery (or other media) retrieval is to be as accurate as possible but WITHOUT excluding a potential candidate, so +/− algorithms provide one side to bring the image(s) being sought and the other to add buffer or margin of error.

When a query is submitted, imagery (or other media) can be returned with a weighted confidence score, which can be a culmination of some or all the weights associated with each individual variable. In a simple scenario, find photos taken on Jul. 13, 2012 can provide photos with a 100% weight, as these are undisputed photos taken on that day. However, when a new vector is added, the percentage opportunity for failure may increase greatly. Allowing not only weighting but also the use of two separate routes to get to the same result can be useful when a vector that a user queries on returns a 0 confidence result.

Either based on user error or our technology is not familiar with the query, the asset being sought for does not believe the query applies to images. So a photo taken Jul. 12, 2012 with a user's dog can have three vectors: (1) the specific date, (2) “with” infers that a human is in the image, and (3) HIS/HER dog. The weights can be applied as follows: (1) The Date: Opportunity for a 100% match. (2) Infers is a risk and therefore is it a requirement that the dog and a human are in the photo or just the dog. Is he/she inferring that they (the querier) is in the image with the dog or just someone else, therefore a weight can be applied to each of these conditions but the chance of failure is higher than “x.” (3) MY DOG: photos where a perfect match with a known asset “the dog” can be applied a very high but not 100% confidence in some embodiments, the images where there is an asset that looks like an animal but not specifically the dog (blurred perhaps), or in a worst case we cannot find a dog.

Therefore when returning results to a user, it can be beneficial to provide the results of the imagery (or other media) with a high confidence score, but also provide a buffer around the imagery (or other media), of which the buffer is determined by the overall confidence the algorithm has that the image set is accurate. This is the human version of, “this is perfect/we are confident/we are quite sure/we are relatively sure” and so on.

The application 118 can also determine the lowest possible combined weight of an image return so as to believe we have found what the user is seeking. This lowest viable score may be different in each scenario and each unique query and is not solely contingent on the query but also on the images retrieved. The lowest acceptable score can be generated when the user query and the data set being queried is made.

EXAMPLE ALGORITHMS: The back end server 120 (and/or the application 118) can perform some or all of the following example processes:

(1) An overall algorithm to identify and sort by:
a. Date
b. Time (or range of time—non numerical)
c. Location (or range of areas)
d. People (By gender, age and recognition)
e. Assets (custom defined)
f. Sentiment Analysis
g. Activity Analysis
h. Sequence (Images that naturally belong together)

(2) A weighting algorithm that defines:
a. The chance of error based on the query
b. The chance of error based on the query and the data set of the imagery (or other media)
c. An overall confidence score on the results generated

(3) Intelligence/Machine Learning
a. Recognizing “you” or common “people”
b. Recognizing “home” or similar custom locations
c. Common trends in photos
d. How you write (natural language processing) and the images you accept as a positive result

APPLICATION LAYER: The application layer can define how we deliver this information. The application 118 can deliver data in one or more of the following four ways, among possibly others:
(1) Consumer Mobile Application for any platform, such as Android™, iOS™, Windows™ & Blackberry™
(2) Consumer Web Dashboard
(3) Business Application Server
(4) API & ETL

CONSUMER MOBILE APPLICATION: The application 118 can provide a mobile app that sources imagery (or other media) existing in the camera roll or similar repository on the camera as well as any linked repository devices such as social sites or Dropbox™-style cloud data storage. The user can then review and assign data to groups/clusters of photos based on what users currently believe is the way to handle imagery (or other media), such as sequences of images that belong together around a period of time or event. Once the process has been completed by the users, some or all imagery (or other media) may be restored back to a large repo environment and can then be called upon via icons, free text sentence search or our recommendations. From the generated images, a user can then create a board to store the results and. can share such board with other users of the application 118, who can add/edit/view the board based on the permissions granted. The ecosystem of the mobile application can gradually educate the user to search for photos the same way he/she thinks about recalling photos in his/her brain.

MOBILE APP CAMPAIGN: Within an optional campaign, the application 118 can provide a reward- or points-based system that allows users to accrue rewards or points for undertaking certain actions or goals. These points can then be redeemed for a variety of products or can be converted to a cash donation to a charity.

CONSUMER WEB DASHBOARD: The back-end server 120 can provide a front end web interface to allow the same functionality available on the mobile application as a web service. Primarily designed to allow for more screen real estate for the user to be able to complete actions quicker, this web view also allows for the synchronization, backup and integration of imagery (or other media) into third party services or local download and image manipulation. Despite the mobile application being an example primary control device for the user, photo management is still a battle won on the desktop as more can be accomplished based on real estate and web functionality.

Application Programming Interface (API): The back-end server 120 and/or application 118 can provide an API to allow integration of its intelligence system into third party environments. This would allow others with a large store of imagery (or other media) to use the API to sort, organize, or query, among other actions.

In still other embodiments, voice prompting can be used by the application 118 to interact with the user. For instance, a user may take a new photo or upload new media to a device associated with the application 118, the application when a teammate automatically analyze the media and output via voice (and/or text) a query to the user as to whether certain metadata is appropriate to take the media with. As an example, the application 118 might output audio that says, “is this a picture of your mother-in-law?” or “tag this picture with ‘mother-in-law?’”

In certain embodiments, the facial recognition features described herein can be performed using neural processing or neural network processing.

Further, in certain embodiments, the features described herein are device agnostic in that any of the functionality of the application 118 can be performed in the cloud (e.g., in the backend server 120). Further, the application 118 can obtain the media from the cloud (e.g., in the backend server 120 or from a web service) instead of or in addition to from the camera roll in the device implementing the application 118. For example, the application 118 may scan the user's social media for images, including Instagram™ and Facebook™ posts as well as Twitter™ posts for images.

In certain embodiments, the application 118 automatically groups media items based on one or more different types of metadata or criteria, which may or may not include events as shown in FIG. 16. For example, when a user invokes the application 118, the application 118 can automatically assign tags to media items that have not yet been tagged (or which have already been tagged and are to be assigned additional tags or new tags based on further information obtained). This automatic assignment can be performed based on any metadata or enhanced metadata such as location, time, date, color (see FIG. 25), combinations of the same or the like. In one embodiment, the application 118 ranks metadata keywords based on the frequency with which they are generated for a particular media item or group of media items. An item might be assigned the location Brazil, for instance, based on GPS data associated with the device as well as calendar data stored in the device, resulting in multiple instances of the term Brazil being associated with the media item. The application 118 may group media items based on the most commonly occurring keywords associated with media items. Further, a search bar output by embodiments of the application 118 (see, e.g., FIG. 25) can include suggested keywords that are from the top-ranked tags or metadata keywords associated with each media item. Thus, the application 118 can suggest automatic groupings or categorizations or tags for any media item or a group of media items and may optionally request the user to confirm whether such groupings are valid or allow the user to edit these groupings.

Any of the functionality described herein as being implemented by the application 118 may also be implemented in whole or in part by the backend server 120, other than displaying information to a user. Any reference herein to photos or video can also be used interchangeably to describe the other, such that any description or reference by the application 118 to one type of media can also be used to perform similar functionality on other types of media.

### VI. Terminology

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

It is to be understood that not necessarily all such advantages can be achieved in accordance with any particular embodiment of the embodiments disclosed herein. Thus, the embodiments disclosed herein can be embodied or carried out in a manner that achieves or optimizes one advantage or group of advantages as taught herein without necessarily achieving other advantages as may be taught or suggested herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A media management method comprising:
under control of a user device comprising a hardware processor:
accessing initial metadata associated with content obtained by a camera;
using the initial metadata to obtain enhanced metadata;
associating the enhanced metadata with the content in computer storage of the user device;
subsequently receiving a user request to search media items, the user request comprising one or more keywords; and
in response to receiving the user request, searching the enhanced metadata with the one or more keywords to identify one or more of the media items associated with the enhanced metadata, and outputting the one or more media items for presentation to the user.

2. The method of claim 1, wherein said using the initial metadata to obtain enhanced metadata comprises requesting the enhanced metadata from a remote server.

3. The method of claim 1, wherein the initial metadata comprises one or more of the following: a date associated with the one or more media items, a time associated with the one or more media items, and a location associated with the one or more media items.

4. The method of claim 3, wherein the location comprises a latitude value and a longitude value.

5. The method of claim 4, wherein the enhanced metadata comprises a location represented other than by latitude and longitude, which is received in response to sending the latitude value and the longitude value to a remote server.

6. The method of claim 1, wherein said using comprises using the initial metadata to access the enhanced metadata from a calendar application used by the user device.

7. The method of claim 1, further comprising presenting the enhanced metadata to the user for review and optional revision.

8. The method of claim 1, further comprising using the enhanced metadata to obtain second enhanced metadata.

9. The method of claim 8, wherein the enhanced metadata comprises a location and the second enhanced metadata comprises an event that occurred at the location.

10. The method of claim 1, wherein said searching further comprises searching the initial metadata.

11. A media management system comprising:
a user device comprising a hardware processor programmed with executable instructions stored in a memory, the executable instructions configured to:
access initial metadata associated with content obtained by a camera;
use the initial metadata to obtain enhanced metadata;
associate the enhanced metadata with the content in computer storage of the user device;
subsequently receive a user request to search media items, the user request comprising one or more keywords; and
in response to receipt of the user request, search the enhanced metadata with the one or more keywords to identify one or more of the media items associated with the enhanced metadata, and output the one or more media items for presentation to the user.

12. The system of claim 11, wherein the initial metadata comprises a tag created by vocal recognition software.

13. The system of claim 11, wherein the instructions further comprise functionality to organize the media items into folders.

14. The system of claim 13, wherein the instructions further comprise functionality to share one of the folders with a remote user.

15. The system of claim 11, wherein the instructions further comprise functionality to order printing of one or more of the media items.

16. Non-transitory physical computer storage comprising instructions stored thereon that, when executed by one or more processors, cause the one or more processors to implement media management operations, the operations comprising:
identifying metadata associated with media items, the media items generated by a camera of a user device;
associating the metadata with the media items in computer storage of the user device;
subsequently receiving a user request to conduct a search on the user device to find one or more of the media items generated by the camera of the user device, the user request comprising one or more keywords; and
in response to receiving the user request,
searching the metadata with the one or more keywords to identify one or more of the media items associated with the metadata, and
outputting the one or more media items corresponding to the one or more keywords for presentation to the user.

17. The non-transitory physical computer storage of claim 16, wherein the operations further comprise receiving voice-dictated data, causing the voice-dictated data to be converted to text, and associating the text with one or more of the media items as a portion of the metadata.

18. The non-transitory physical computer storage of claim 16, wherein the operations further comprise providing a user interface comprising a user interface control that is user-selectable to conduct the search.

19. The non-transitory physical computer storage of claim 16, wherein the operations further comprise providing a user interface comprising a user interface control that is user-selectable to share selected media items of the media items with another user.

20. The non-transitory physical computer storage of claim 16, wherein the operations further comprise providing a user interface comprising a user interface control that is user-selectable to cause selected media items of the media items to be printed.

21. The non-transitory physical computer storage of claim 16, wherein the metadata comprises color information about at least some of the media items.
